(19) United States
(12) Patent Application Publication
(10) Pub. No.: US 2014/0102479 A1
(43) Pub. Date: Apr. 17, 2014

(54) ZONED FILTRATION FOR LIQUID-FILLED CONTAINERS

(71) Applicants: Carl Alan Steffen, Schertz, TX (US); Dave Koontz, Schertz, TX (US)

(72) Inventors: Carl Alan Steffen, Schertz, TX (US); Dave Koontz, Schertz, TX (US)

(21) Appl. No.: 14/050,033

(22) Filed: Oct. 9, 2013

Related U.S. Application Data
(60) Provisional application No. 61/744,962, filed on Oct. 9, 2012.

(51) Int. Cl. B08B 9/093; B01D 35/02

(52) U.S. Cl. CPC B08B 9/093; B01D 35/02
USPC 134/10; 134/110

(57) ABSTRACT

A system for removing material from a container includes a plurality of fluid delivery devices, one or more pumps, and a control system. The fluid delivery devices may include jets that can stream fluid across a surface of the container and pipes that can carry liquid to the jets. The control system can control flow to the fluid delivery devices to selectively allow flow from the system to two or more different zones in the container.

### PRIORITY CLAIM

This application claims priority to U.S. Provisional Application Ser. No. 61/744,962 entitled “ZONED FILTRATION FOR COOLING TOWER AND EVAPORATIVE CONDENSER BASINS/SUMP TANKS” filed Oct. 9, 2012, which is incorporated herein by reference in its entirety.

### BACKGROUND

1. Field

The present invention relates to cleaning containers or vessels. More particularly, the present invention relates to filtration systems for removing debris and solids from liquid-filled vessels, such as cooling towers and sump tanks.

2. Description of the Related Art

Filtration systems are sometimes used to remove solids or debris from liquid-filled vessels, such as cooling towers, evaporative condenser, and other liquid filled vessels. The force and flow required for moving debris within cooling towers, evaporative condenser or other liquid filled vessel may require the use of large filtration systems with pumps having adequate flow and force to move the debris towards the filtration systems inlet for removal. A typical performance goal for the system is to achieve a 1 gallon per minute (GPM) sweeping flow per square foot of tower basin or vessel area. While this level may provide adequate cleaning, it also imposes high energy and flow requirements for the system.

In a typical side stream arrangement for moving, collecting and filtering debris from a vessel, all of the liquid from a side stream filtration system is continuously used to move debris to the solids collection device. Such a stream may require, as an example, a 200 gallon per minute (“GPM”) filtration system to maintain 1 gallon per minute per square foot (“GPM/ft²”) of water flow for effective solids removal.

### SUMMARY

Systems and methods for controlling the cleaning of basins, troughs, sumps, tanks, or other solids (debris) collecting structures are described herein. In an embodiment, a system for removing material from a container (for example, a cooling tower tank) includes a plurality of fluid delivery devices, one or more pumps, and a control system. The fluid delivery devices may include jets that can move fluid across a surface of the container and pipes that can carry liquid to the jets. The control system can control flow to the fluid delivery devices to selectively allow flow from the system to two or more different zones in the container. There is no limit to the number of zones or sets of sweeper jets.

In an embodiment, a method for removing material from a container includes supplying fluid from a fluid source to a first set of sweeper jets such that the first set of sweeper jets forces fluid across a first zone of a bottom of the container. After supplying fluid from the fluid source to the first set of sweeper jets, a flow of fluid from the fluid source is switched to a second set of sweeper jets such that the second set of sweeper jets forces fluid across a second zone of the bottom of the container.

In an embodiment, a filtration system includes a plurality of fluid delivery devices, one or more pumps, and one or more filters. The fluid delivery devices include jets that can stream fluid across one or more zones in a bottom surface of a container. A first one of the fluid delivery devices can stream fluid across a first zone in the bottom of the container to a drain. A second one of the fluid delivery devices can stream fluid across a second zone in the bottom of the container. The one or more filters remove from a liquid at least a portion of the material swept by the fluid delivery devices in the drain (for example, solids and/or debris).

### BRIEF DESCRIPTION OF THE DRAWINGS

FIG. 1 is a plan view illustrating one embodiment of a system for moving, collecting, and filtering debris from a vessel.

FIG. 2 is an elevation view illustrating one embodiment of a system for moving, collecting, and filtering debris from a vessel.

FIG. 3 illustrates one embodiment of a system with sweeper jet arrays for sweeping debris from adjacent zones of a vessel.

FIG. 4 illustrates one embodiment of a system with a ring of fluid delivery devices for sweeping debris to a suction manifold of a filtration system.

FIG. 5 illustrates one embodiment of a system having a series of fluid delivery devices for sweeping debris to a suction manifold of a filtration system.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF ILLUSTRATIVE EMBODIMENTS

As used herein, a “container” means any device, structure, or apparatus that can hold a fluid. Examples of containers include vessels (pressurized or unpressurized), cooling towers, evaporative condenser basins, fruit and produce washers, and sump tanks. In some embodiments, a container holds a liquid.

As used herein, “jet” means any device or structure that can spray, stream, propel, or insert fluid into a space. In some embodiments, a jet includes a nozzle.

As used herein, a “sweeper jet” means a jet that can be positioned to spray, stream, propel fluid across a surface to sweep material from the surface. For example, a sweeper jet may propel liquid across the floor of a vessel.

In some embodiments, the use of a zoned discharge of filtered water using a sweeper jet system reduces the required filtration force and energy requirements, and improves the overall solids removal efficiency.

In an embodiment, a side stream filtration system with an integrated suction manifold is placed into the basin or sump combined with multiple zones of sweeper jets to move solids/debris towards the suction manifold for removal. This method may involve control of the sweeper jet systems so that multiple zones are created to maximize cleaning efforts, while minimizing the power requirements of the side stream filtration system.

In some embodiments, a method includes arranging and controlling sweeper jet arrays for the movement of debris towards a filtration system's suction manifold. The suction manifold may include a connection in a cooling tower, evaporative condenser or other liquid-filled vessel to aid in the removal of solids and debris formed during the normal operation of the process, tower or evaporative condenser.

In some embodiments, a basin sweeping system enhances the flow per square foot of basin as needed for sites where the excessive debris loading may occur.

In one embodiment, a sweeper system creates two or more zones, each zone of which can be driven by the full flow of the filtration system at alternating times to move debris to the suction manifold. Each zone may use the full flow of the filtration system. Flow to the sweeper jets may be controlled by an automated system that alternatively turns on and off the water flow to each zone using filtered liquid for debris removal. A zoned distribution system may use less energy and a smaller liquid driving flow than a non-zoned system (which may distribute fluid to all of the swept area whenever the system is on) with the same number of nozzles and area of coverage.

In this embodiment, by using the flow for half of the system at any one time, a filtration system may be reduced compared to an entire-flow system, while maintaining a given flow rate per unit area water flow for effective solids removal.

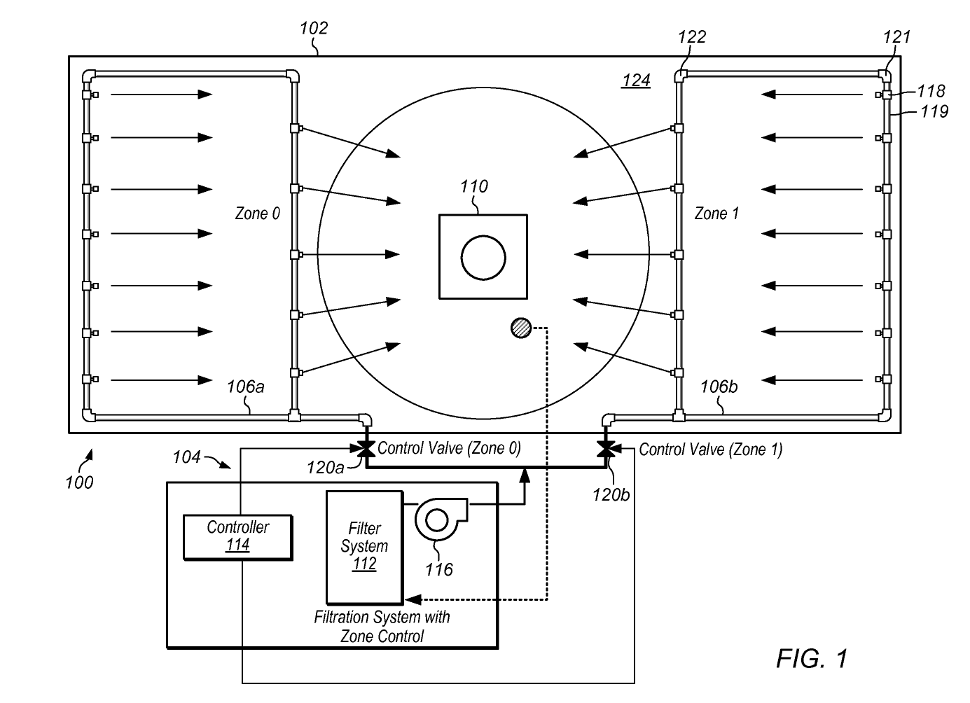

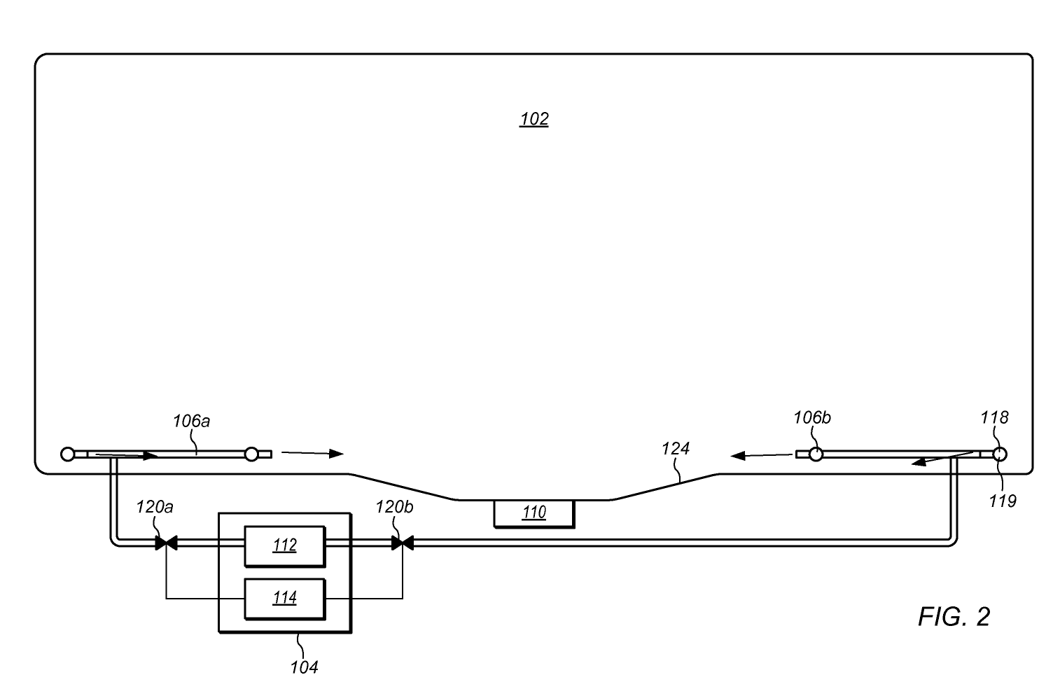

FIG. 1 is a plan view illustrating one embodiment of a system for moving, collecting, and filtering debris from a vessel. FIG. 2 is an elevation view illustrating one embodiment of a system for moving, collecting, and filtering debris from a vessel. System 100 includes container 102 and solids/debris removal system 104. Container 102 may be, for example, a tank of a cooling tower.

Filtration system 104 includes fluid delivery devices 106a, 106b, suction manifold 110, filter system 112, controller 114, and pump 116. Fluid delivery devices 106a and 106b include sweeper jets 118 and pipes 119. Pipes 119 may deliver fluid from pump 116 to sweeper jets 118.

Controller 114 may operate control valves 120a and 120b to control flow to sweeper jets 118 in fluid delivery devices 106a and 106b. Sweeper jets 118 may propel fluid across floor 124 of container 102. In some embodiments, the sweeping fluid is a liquid. Sweeper jets 118 may be arranged in rows 121 and 122. Each of rows 121 and 122 include an array of sweeper jets 118. In some embodiments, sweeper jets 118 include nozzles. The nozzles may discharge fluid in a pattern, direction, and velocity that promotes removal of solids or debris from the area being swept. Sweeping of solids/debris may be performed during operation of the primary system (for example, while the cooling tower is operating to cool a building.)

A portion of the liquid moving over bottom surface 124 of container 120, as well as solids or debris displaced by the moving fluid, may pass into suction manifold 110. In some embodiments, bottom surface 124 may slope downward toward suction manifold 110. Suction manifold 124 may serve as a drain for fluid moved toward the middle of container 120.

Liquids, solid, and debris entering suction manifold 110 may be carried to filter system 112. Filter system 112 may include one or more filters. The filters may remove material being carried by the stream, such as solids or debris swept from bottom surface 124.

Controller 114 may control valves 120a and 120b to alternately channel fluid to fluid delivery device 106a or fluid delivery device 106b. In this manner, all of the energy from a fluid source (for example, fluid pumped by pump 116) may be focused on one zone of a container. For example, initially, valve 120a may be open and valve 120b may be closed such that the flow from pump 116 is all directed to Zone 0. Once Zone 0 has been swept to a desired degree, controller 114 may be operated to switch valve 120a to a closed position and valve 120b to an open position, such that the flow from pump 116 is all directed to Zone 1. In certain embodiments, flow may be divided among two or more zones (for example, some to Zone 0 and the rest to Zone 1).

In some embodiments, a control system for a multi-zone sweeping system (such as filtration system 104) includes a programmable logic controller (“PLC”). In some embodiments a control system includes one or more computing devices. As used herein, “computing device” includes any of various devices in which computing operations can be carried out, such as computer systems or components thereof. As used herein, the term computing device is not limited to just those integrated circuits referred to in the art as a computer, but broadly refers to a processor, a server, a microcontroller, a microcomputer, an application specific integrated circuit, and other programmable circuits. In some embodiments, a control system operates using program instructions provided by a user.

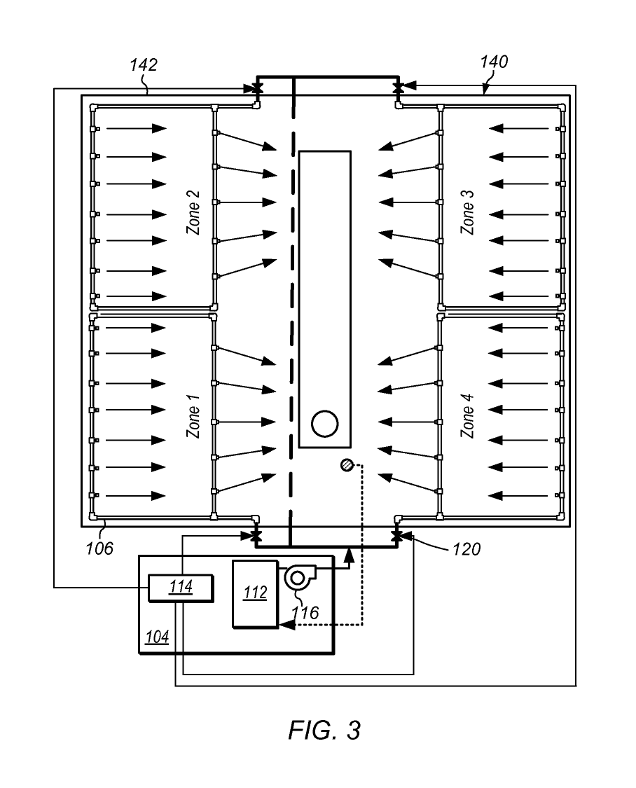

In some embodiments, a sweeper system can be used to sweep two or more adjacent zones in a container. FIG. 3 illustrates one embodiment of a system with sweeper jet arrays for sweeping debris from adjacent zones of a container. System 140 includes container 142 and filtration system 104. Filtration system 104 includes controller 114 and fluid delivery devices 106. A separate fluid delivery device is provided for each of Zones 1, 2, 3, and 4. Controller 114 may be operated to open and close valves 120 as needed to isolate flow from pump 116 to one or more selected zones. For example, at a given time, fluid delivery devices 106 may be operated to sweep material in Zone 1, adjacent Zone 2, or both.

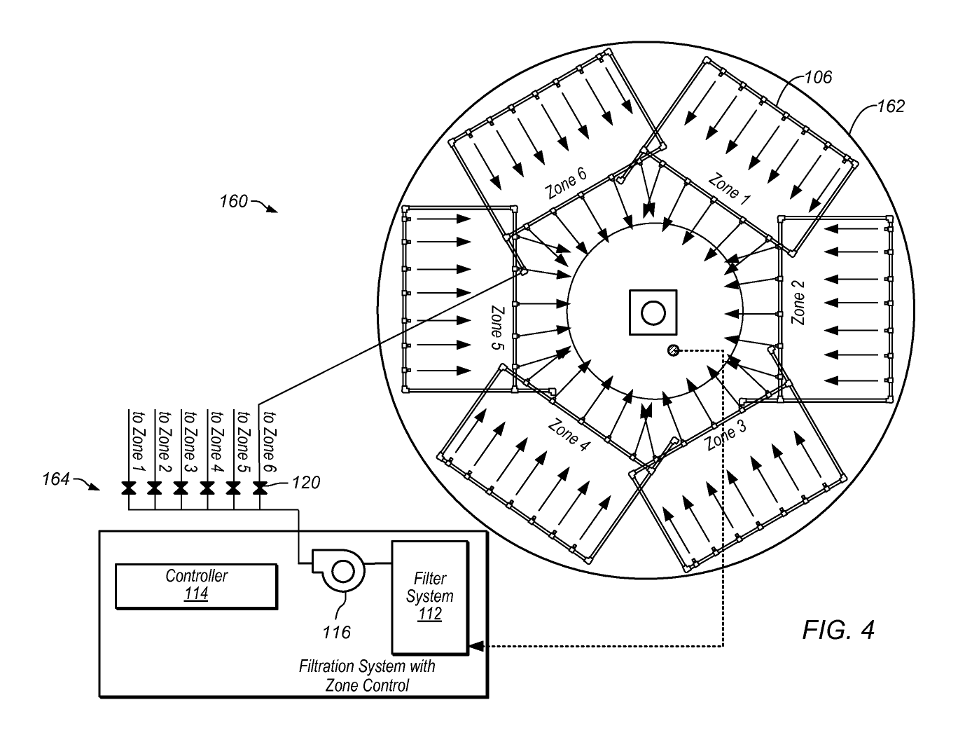

In some embodiments, sweeper jet arrays are arranged to move liquid in different zones in different directions. FIG. 4 illustrates one embodiment of a system with a ring of fluid delivery devices for sweeping debris to a centrally located suction manifold of a filtration system. System 160 includes container 162 and filtration system 164. Fluid delivery devices 106 are provided for each of zones 1-6. (The supply line from each of valves 120 to a corresponding fluid delivery device 106 for Zones 1-5 has been omitted from FIG. 4 for clarity). Fluid delivery devices 106 may sweep fluid toward a drain, such as a drain for suction manifold 110. Filtration system 164 may operate valves 120 to control which zone or zones will receive sweep liquids. Controller 114 may control valves 120 to control flow from pump 116 to fluid delivery devices for Zones 1-6 (in FIG. 4, control lines between valves 120 and controller 114 are omitted for clarity).

As illustrated by the arrows in FIG. 4, fluid delivery devices 106 for system 160 may overlap with other fluid delivery devices in a container. In some embodiments, sweeper jets for two or more overlapping zones are supplied with sweeping fluid at the same time (for example, Zones 3 and 4).

Controller 114 may operate valves 120 to selectively sweep any combination of Zones 1-6. For example, opposing Zones 2 and 5 may be swept at the same time as one another. In one embodiment, Zones 1 through 6 are run sequentially around the ring.

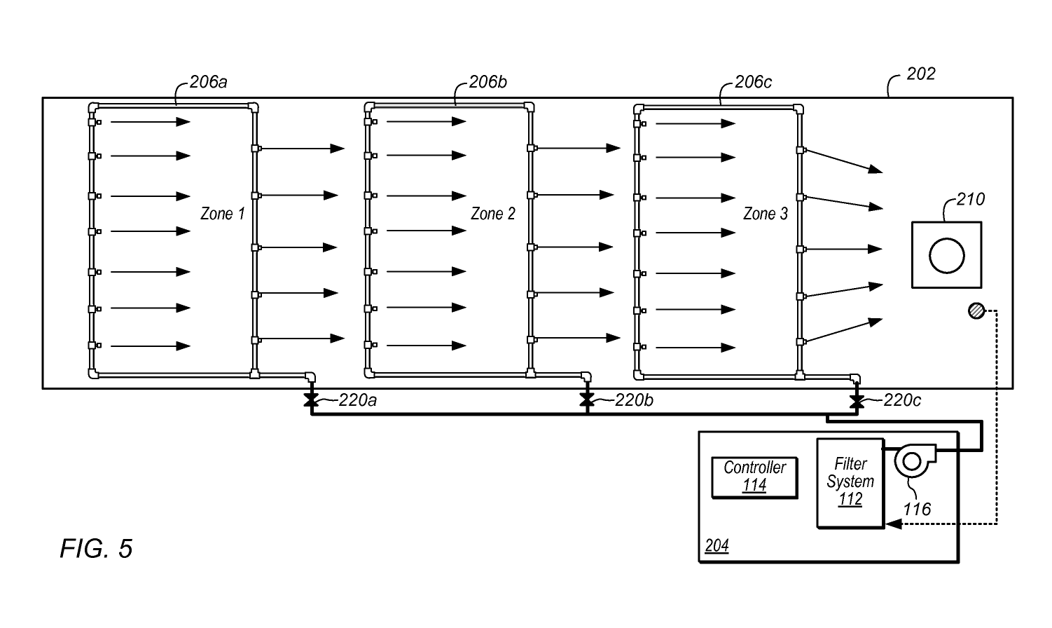

In some embodiments, a filtration system includes sweeping devices that can be operated to sequentially sweep material to a common drain. FIG. 5 illustrates one embodiment of a system having a series of fluid delivery devices for sweeping debris to a suction manifold of a filtration system. System 200 includes container 202 and filtration system 204. Fluid delivery devices 206a, 206b, and 206c may be supplied with fluid in a sequential manner such that solids/debris is swept first from Zone 1 toward Zone 2, then toward Zone 3 and to suction manifold 210.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Methods may be implemented manually, in software, in hardware, or a combination thereof. The order of any method may be changed, and various elements may be added, reordered, combined, omitted, modified, etc. Changes may be made in the elements described herein without departing from the spirit and scope of the invention as described in the following claims.

1. A system for removing material from a container, comprising:
a plurality of fluid delivery devices, wherein at least one of the plurality of fluid delivery devices comprises:
one or more jets configured to stream fluid across one or more zones in a bottom surface of the container; and
one or more pipes configured to carry fluid to at least one of the one or more jets;
one or more pumps configurable to pump fluid through at least one of the one or more jets;
one or more control systems configured to control fluid flow through at least one of the fluid delivery devices;
wherein a first one of the fluid delivery devices is configured to stream fluid across a first zone in the bottom of the container,
wherein a second one of the fluid delivery devices is configured to stream fluid across a second zone in the bottom of the container, wherein the second zone is at least partially different from the first zone,
wherein the control system is configured to at least partially inhibit a flow of fluid through the fluid delivery device for one on of the first or second zones while allowing flow of fluid through the fluid delivery device for the other of the first or second zones.

2. The system of claim 1, wherein the plurality of fluid delivery is configured to sweep the bottom surface of the container.

3. The system of claim 1, wherein the controller is configured to sequentially allow flow to one of the zones at a time while inhibiting flow to the other zones.

4. The system of claim 1, wherein at least one of the fluid delivery devices is configured to sweep material into one or more drains.

5. The system of claim 1, wherein at least one of the fluid delivery devices is configured to sweep material into one or more suction manifolds.

6. The system of claim 1, further comprising one or more filters downstream from one or more drains in the bottom of the container, wherein the one or more filters are configured to filter out at least a portion of the material swept into the drain by the fluid delivery devices.

7-10. (canceled)

11. The system of claim 1, wherein the first zone and the second zone are on opposing sides of a bottom surface of the container.

12. (canceled)

13. The system of claim 0, wherein the plurality of fluid delivery devices comprise three or more fluid delivery devices configured to sequentially sweep three or more zones.

14. The system of claim 1, wherein the plurality of fluid delivery devices comprises two or more rows of jets.

15. The system of claim 1, wherein at least two of the fluid delivery devices are configured to sweep zones that overlap with one another.

16. (canceled)

17. The system of claim 1, wherein the control system comprises valves coupled to the controller, wherein the controller is configured to control the valves to selecting flow fluid through a selected one of the fluid delivery devices.

18. The system of claim 1, wherein control system comprises a controller and one or more valves coupled to the controller, wherein the controller is configured to operate the at least one of the one or more valves isolate flow from the fluid source to one of the fluid delivery devices.

19-20. (canceled)

21. The system of claim 1, wherein the container is a container of a cooling tower.

22. (canceled)

23. The system of claim 1, wherein at least one of the fluid delivery devices is configured to sweep the bottom of the container in a different direction than at least one other of the fluid delivery devices.

24. The system of claim 1, further comprising a carrier mechanism configured to move at least one of the fluid delivery devices from one location to another in the container.

25. (canceled)

26. A method for removing material from a container, comprising:
supplying fluid from a fluid source to a first set of sweeper jets such that the first set of sweeper jets forces fluid across a first zone of a bottom of the container;
after supplying fluid from the fluid source to the first set of sweeper jets, switching a flow of fluid from the fluid source to a second set of sweeper jets toward a filter inlet; and
supplying fluid from the fluid source to the second set of sweeper jets such that the second set of sweeper jets forces fluid across a second zone of a bottom of the container toward the filter inlet.

27-30. (canceled)

31. The method for removing material from a container of claim 26, further comprising filtering at least a portion of material swept by the sweeper jets from a liquid.

32. The method for removing material from a container of claim 26, wherein sweeping of at least one of the zones is performed while a primary system using liquids in the container is in operation.

33. A filtration system, comprising:
a plurality of fluid delivery devices, wherein at least one of the plurality of fluid delivery devices comprises:
one or more jets configured to stream fluid across one or more zones in a bottom surface of the container; and
one or more pipes configured to carry fluid to at least one of the one or more jets;
one or more pumps configurable to pump fluid through at least one of the one or more jets;
wherein a first one of the fluid delivery devices is configured to stream fluid across a first zone in the bottom of the container to a drain,
wherein a second one of the fluid delivery devices is configured to stream fluid across a second zone in the bottom of the container, wherein the second zone is at least partially different from the first zone to the drain, and
one or more filters configured to remove from a liquid at least a portion of material swept by the fluid delivery devices in the drain.

34. (canceled)

35. The system of claim 33, wherein the filtration system is configured to sweep each of two or more zones of the container at different times.

36-37. (canceled)
